(19) United States
(12) Patent Application Publication
(10) Pub. No.: US 2019/0307275 A1
(43) Pub. Date: Oct. 10, 2019

(54) APPARATUS, SYSTEM, AND METHOD FOR SHADING AND COOLING AN ARTICLE

(71) Applicant: Ben Terry Rudd, Pensacola, FL (US)

(72) Inventor: Ben Terry Rudd, Pensacola, FL (US)

(21) Appl. No.: 16/449,845

(22) Filed: Jun. 24, 2019

Related U.S. Application Data
(63) Continuation of application No. 15/857,360, filed on Dec. 28, 2017.

(51) Int. Cl. A47G 23/00; H02S 20/00

(52) U.S. Cl. CPC A47G 23/00; H02S 20/00

(57) ABSTRACT

A system for shading and cooling an article container is disclosed. The system includes a base with a compartment formed within, a cooling element inserted into the compartment, and a collapsible canopy structure extending upwards from the base. The collapsible canopy structure includes a vertical supporting element hingedly attached at its bottom end with the base, and a cantilevered element hingedly attached with a top end of the vertical supporting element. A planar sheet is mounted on the vertical supporting structure and the cantilevered element. The system is configured to move between a storage configuration and an operational configuration. In the operational configuration, the vertical supporting element and cantilevered element provide shading for the article container. The system further includes a plurality of storage pockets attached to an inward facing surface of the planar sheet and a solar panel attached to an outward facing surface of the planar sheet.

### CROSS-REFERENCE TO RELATED APPLICATIONS

This application is a continuation-in-part of U.S. Non-Provisional patent application No. 15/857,360 entitled “Apparatus for Shading and Cooling Articles,” filed Dec. 28, 2017, the subject matter all of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present invention relates to the field of table equipment, and more specifically, to the field of devices for shading and cooling a beverage container and otherwise protecting articles from the sun.

### BACKGROUND

Keeping beverages cold during the warmer months of spring, summer, and early fall is challenging. Drinks become warm under the glare of the hot sun when participating in outdoor activities, such as swimming or lounging poolside. Electromagnetic radiation from the surrounding environment and the sun's rays warms beverage containers, and thus the drinks inside become warm. Further, there are several other articles that cannot withstand ambient heat such as electronic devices (phones, laptops, tablets, hand held gaining devices, etc.) as well as items that the user wants to keep cool such as keys, toys, and other personal items.

Heat is transferred through three mechanisms: conduction, convection, and radiation. Conducted heat occurs across a medium, such as a warm hand touching a beverage container. Convection of heat occurs between a surface and a moving fluid or gas when they are at different temperature. For the purposes of the proposed invention, the moving gas is the ambient air. Thermal radiation occurs when the sun emits electromagnetic waves that travel through space and transform into heat when they come in contact with an absorbing object. These electromagnetic waves can also be substantially reflected away by a reflective object,

There have been several attempts in the prior art to provide shade and or cooling to beverage containers when the ambient temperature rises. For example, a beverage cozy, also known as a “coozy,” is a cylindrical device designed to fit around a standard aluminum beverage can snugly. The device inhibits heat transfer by preventing convective heat transfer front a large percentage of the can's surface area. The cozy also inhibits conductive heat transfer by presenting a material with a low heat transfer coefficient adjacent to the highly conductive aluminum can. However, use of the coozy is limited generally to aluminum cans and specifically shaped containers and does little to reflect thermal radiation. It also does nothing to actively cool the container. Additionally, there are various shading devices in the prior art but none that have the capability to shade a variety of items, including beverages, electronic devices, keys, toys, etc. Nor do they have the ability to actively cool the items with the device.

As a result, there exists a need for improvements over the prior art and more particularly, to provide a device for the shading and cooling of articles to combat conducted, convected, and radiated heat sources.

### SUMMARY

An apparatus, system, and method for shading and cooling an article is disclosed. This Summary is provided to introduce a selection of disclosed concepts in a simplified form that are further described below in the Detailed Description, including the drawings provided. This Summary is not intended to identify key features or essential features of the claimed subject matter. Nor is this Summary intended to be used to limit the claimed subject matter's scope.

In one embodiment, an apparatus for shading an article is disclosed. The apparatus includes a base and at least two legs. Each leg has a top end and a bottom end. A first hinging element hingedly connects the bottom end of each leg with the base such that each leg moves between a storage configuration and an operational configuration. In the storage configuration, the top end of each leg is proximate to the base. In the operational configuration, each leg is vertically arranged such that each leg provides vertical structure support.

The apparatus further includes at least two arms. Each arm has a frontward end and a rearward end. A second hinging element hingedly connects the rearward end of each arm with the top end of one of the legs such that each arm moves between the storage configuration and the operational configuration. In the storage configuration, the frontward end of each arm is proximate to the bottom end of one of the legs. In the operational configuration, each arm is horizontally arranged such that each arm provides horizontal structure support. A first connector connects each of the legs near the bottom end of the legs. A second connector connects each of the arms near the forward ends of the arms. A third connector connects each of the legs near the top end of the legs. A fourth connector connects each of the arms near the rearward end of the arms.

The apparatus further includes a sheet of material. In the operational configuration, a bottom end of the sheet of material is mounted on the first connecter, and the top end of the sheet of material is mounted on the second connector such that a first surface of the sheet of material faces towards the base and a second surface faces away from the base.

In another embodiment, a system for shading and cooling an article container is disclosed. The system includes a base, a cooling element inserted into the compartment, and a collapsible canopy structure extending upwards from the planar base.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplars d explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a front perspective view of an apparatus for shading an article, according to an example embodiment of the present invention;

FIG. 2A is a side view of an apparatus for shading an article, according to an example embodiment of the present invention;

FIG. 2B is a magnified side view of a portion of the area enclosed within circle A of FIG. 2A, wherein the leg is in a first position relative to the base according to an example embodiment of the present invention;

FIG. 2C is a magnified side view of a portion of the area enclosed within circle A of FIG. 2A, wherein the leg is in a second position relative to the base according to an example embodiment of the present invention;

FIG. 3A is a side view of an apparatus for shading an article, according to an example embodiment of the present invention;

FIG. 3B is a magnified side view of a portion of the area enclosed within circle C of FIG. 3A, according to an example embodiment of the present invention;

FIG. 4A is a side view of an apparatus for shading an article, wherein the arms are rotating away from the base according to an example embodiment of the present invention;

FIG. 4B is a magnified side view of a portion of the area enclosed within circle E of FIG. 4A, wherein the arms are rotating away from the base according to an example embodiment of the present invention;

FIG. 5 is a front perspective view of an apparatus for shading an article, wherein the arms are rotating away from the base according to an example embodiment of the present invention;

FIG. 6 is a front perspective view of an apparatus for shading an article moving from an operational configuration to a storage configuration according to an example embodiment of the present invention;

FIG. 7A is a side view of an apparatus for shading an article in a storage configuration, according to an example embodiment of the present invention;

FIG. 7B is a magnified side view of a portion of the area enclosed within circle I of FIG. 7A, according to an example embodiment of the present invention;

FIG. 8 is a top perspective view of an apparatus for shading an article in a storage configuration, according to an example embodiment of the present invention;

FIG. 9 is a top perspective view of an apparatus for shading an article in a storage configuration, wherein the first part of a fastener is attached to a second part of a fastener according to an example embodiment of the present invention;

FIG. 10 is a front perspective view of a system for shading and cooling an article container, according to an example embodiment of the present invention;

FIG. 11 is a rear perspective view of a system for shading and cooling an article container, according to an example embodiment of the present invention; and

FIG. 12 is a flowchart describing the steps of the process for shading and cooling an article container, according to an example embodiment of the present invention.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The present invention improves upon the prior art by providing an apparatus, system, and method for cooling an article container to combat conducted, convected, and radiated heat sources. The system includes a base with a compartment formed within that contains a cooling element, such as an ice pack, to keep the article container cold.

The present invention also improves upon the prior art by providing an apparatus, system, and method for shading an article container to combat conducted, convected, and radiated heat sources.: collapsible canopy structure extending upwards from the base includes a vertical supporting element hingedly attached at its bottom end with the base, and a cantilevered element hingedly attached with a top end of the vertical supporting element. A planar sheet is mounted on the vertical supporting structure and the cantilevered element to provide shading for the article container. The planar sheet is comprised of a material that is water resistant and reflects the sun. Additionally, a plurality of storage pockets is attached to an inward facing surface of the planar sheet, and a solar panel is attached to an outward facing surface of the planar sheet.

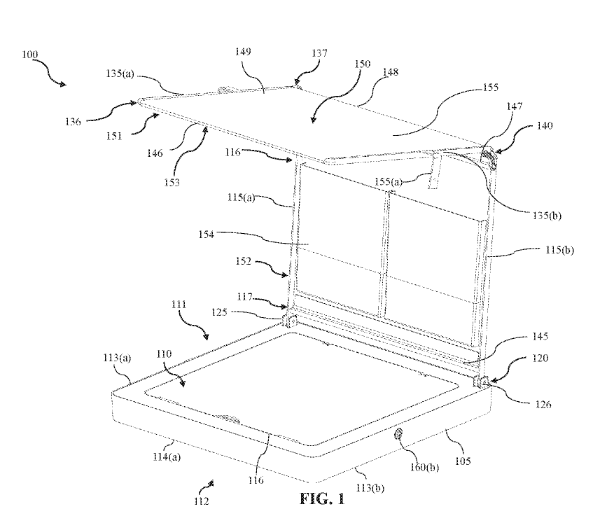

Referring now to the Figures, FIG. 1 illustrates an apparatus 100 for shading an article. The apparatus includes a base 105 having a storage compartment 110 formed within. In the present embodiment, the base 105 has a substantially planar square shaped body with rounded corners comprising an upward facing side 111, a downward facing side 112, two opposing sidewalls 113(a), 113(b) and two opposing end walls 114(a), 114(b). It should be appreciated that the base can have other shapes and dimensions, and such variations are within the spirit and scope of the claimed invention. In another embodiment, the base may have a dedicated area for adding a message, logo, or other personalized item. The base may be comprised of materials such as galvanized steel or iron, copper, polybutylene, unplasticized polyvinylchloride (PVC), chlorinated polyvinylchloride (CPVC) and polyethylene (PE) to increase corrosion resistance to specific environments, enhance oxidation resistance, and impart special characteristics.

A divider panel 116 enclosing the storage compartment 110 is located on the upward facing side 111 of the base 105. The divider panel 116 may be connected to the base using a hinged connection or any other connection that allows the divider panel 116 to be lifted upwards so that items may be placed in the compartment created therein. As further discussed below, the storage compartment 110 is configured to receive a cooling element. The divider panel 116 may be formed from the same material as the base 105 or may be formed from another suitable material.

The apparatus includes at least two legs 115(a), 115(b). Each leg has a top end 116 and a bottom end 117. In the present embodiment, the legs have a substantially planar rectangular shaped body, however, it should be appreciated that the legs can have other shapes and dimensions, and such variations are within the spirit and scope of the claimed invention.

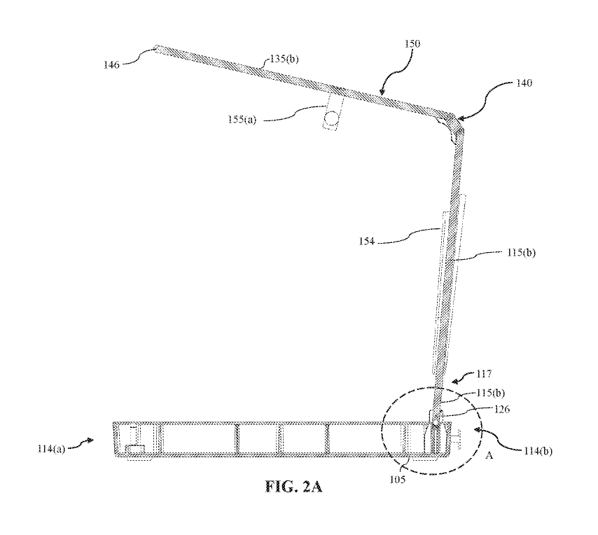

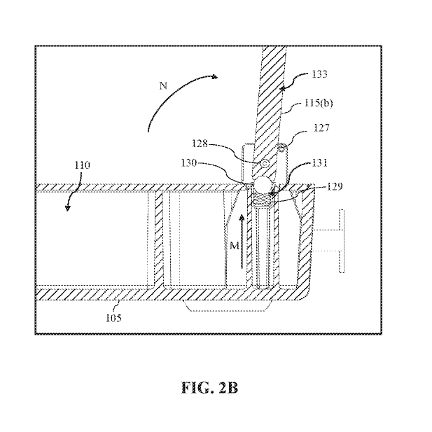

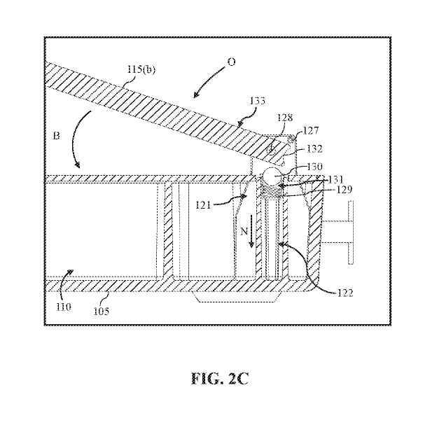

FIG. 2A illustrates a first hinging element 120 that hingedly connects the bottom end 117 of each leg 115(a), 115(b) with the base 105 such that each leg moves between a storage configuration and an operational configuration. As shown in further detail in FIGS. 1, 2A, 2B and 2C, the first hinging element 120 comprises a first wall 125 facing a second wall 126, wherein the first and second wall protrude upward from the base 105. A rearward support bar 127 spans from the first wall to the second wall, and a pin 128 pivotally couples the leg relative to the first wall and second wall. Additionally, a resilient element 129 is positioned between the first and second wall and includes a ball 130 positioned on top of the upper end 131 of the resilient element. In the present embodiment, the resilient element is a pre-loaded, commonly wound torsion spring 129 that is configured to exert an upward force on the ball 130 positioned on top of the upper end 131 of the torsion spring. The torsion spring and the ball are retained within a housing 121 located inside a channel 122 on the upward facing side 111 of the base 105. The housing is comprised of a central opening, an end wall, and two side walls. The central opening of the housing is bent inwardly to form a flange (not shown) which is configured to retain the ball and maintain the torsion spring under a predetermined compression. It should be appreciated that other resilient elements may be used within the housing or inside the channel, and such variations are within the spirit and scope of the claimed invention.

FIG. 2B is a magnified side view of the first hinging element enclosed within circle A of FIG. 2A in the operational configuration, wherein each leg is vertically arranged such that each leg provides vertical structure support. In the operational configuration, the rearward facing side 133 of each leg is supported by the rearward support bar 127 and the resilient element 129. When a force (in the direction of arrowed line N) rotates each leg to substantially vertically aligned position, the resilient element is configured to exert an upward force (in the direction of arrowed line M) on the ball positioned on top of the upper end of the torsion spring to engage a groove 132 on the bottom end 117 of each leg.

FIG. 2C is a magnified side view of the first hinging element enclosed within circle A of FIG. 2A moving from the operational configuration to the storage configuration (in the direction of arrowed line B). To move from the operational configuration to the storage configuration, a three is applied (in the direction of arrowed line O) on each leg, which in turn exerts a downward force (in the direction of arrowed line N) on the resilient element to disengage the ball from the groove 132 on the bottom end 117 of each leg.

The apparatus 100 further includes at least two arms 135(a), 135(b). Each arm has a frontward end 136 and a rearward end 137. In the present embodiment, the arms have a substantially planar rectangular shaped body, however, it should be appreciated that the arms can have other shapes and dimensions, and such variations are within the spirit and scope of the claimed invention.

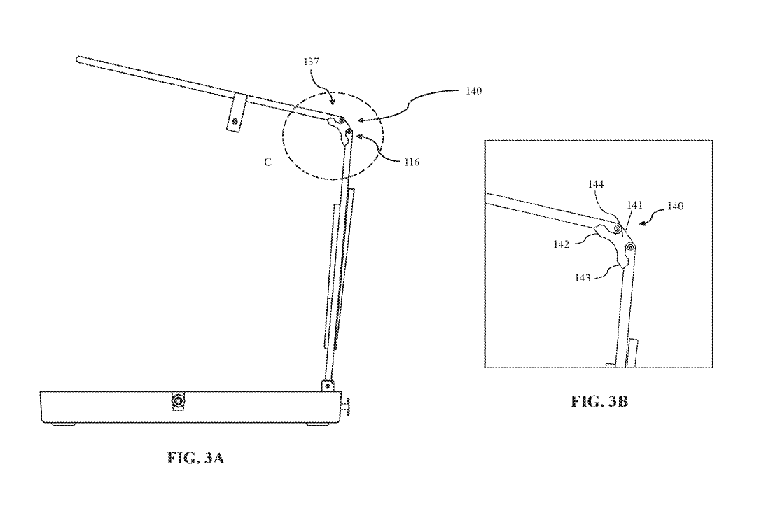

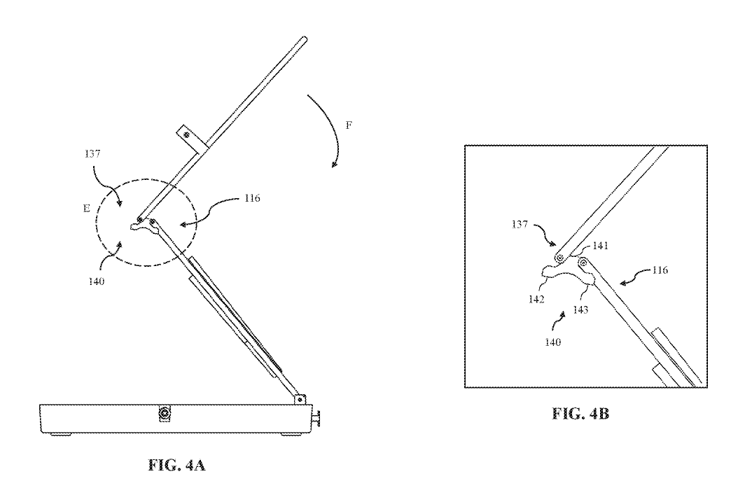

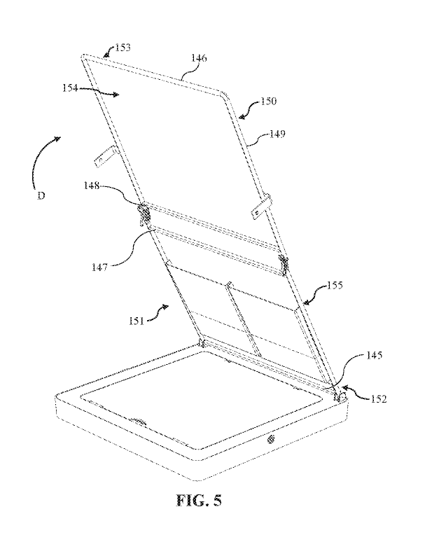

FIG. 3A illustrates a second hinging element 140 that hingedly connects the rearward end 137 of each arm with the top end 116 of one of the legs such that each arm moves between the storage configuration and the operational configuration. FIG. 3B is a magnified side view of the second hinging element 140 enclosed within circle C of FIG. 3A in the operational configuration, wherein each arm is horizontally arranged such that each arm provides horizontal structure support. FIG. 4A illustrates a side view of the apparatus further moving from the operational configuration to the storage configuration (in the direction of arrowed line F). FIG. 4B is a magnified side view of the second hinging element enclosed within circle E of FIG. 4A, wherein the frontward end of each arm is proximate to the bottom end of one of the legs.

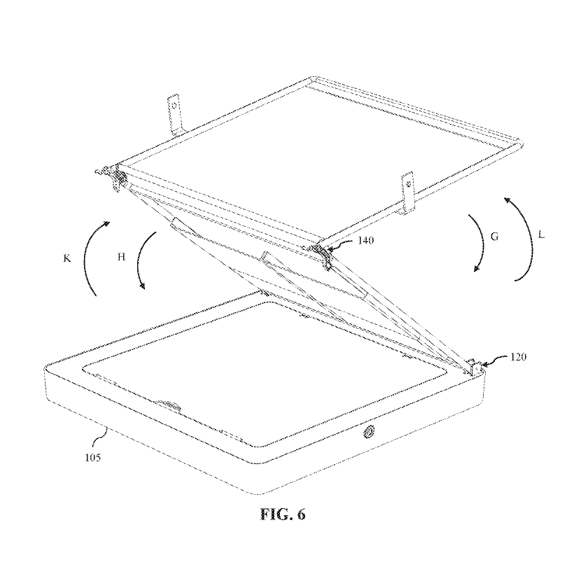

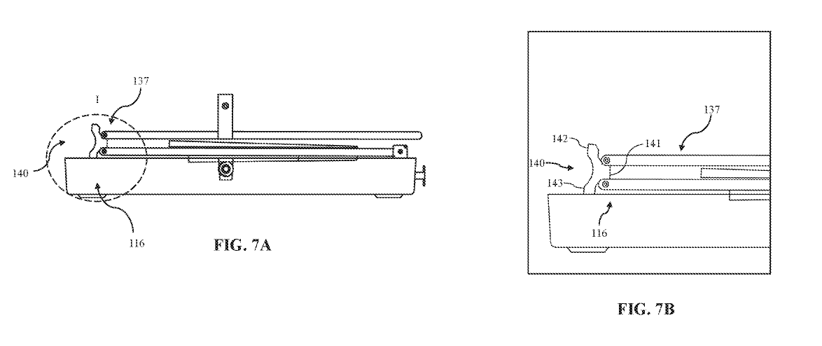

The second hinging element 140 comprises a support element 141 having a first abutting part 142, a second abutting part 143, and a connecting part 144. The connecting part is configured to pivotally connect one of the arms to one of the legs. In the operational configuration, as shown in FIGS. 3A and 3B, the first abutting part 142 abuts the downward facing side of the arm and the second abutting part 143 abuts the forward-facing side of the leg to provide an upward force to maintain the apparatus in the operational configuration. Moreover, FIG. 5 illustrates a perspective view of the apparatus 100 moving from the operational configuration to the storage configuration. The second hinging element 140 is configured such that each of the arms rotate away from the base (in the direction of arrowed line D) when moving from the operational configuration to the storage configuration. In the storage configuration, as shown in FIGS. 7A and 7B, the first abutting part 142 and the second abutting part 143 do not a butt the leg and the arm.

FIG. 6 is a front perspective view of the apparatus 100 for shading an article moving from an operational configuration to a storage configuration, according to an example embodiment of the present invention. The first hinging element 120 is configured such that each of the legs rotate toward the base the direction of arrowed line when moving from the operational configuration to the storage configuration. The second hinging element 140 is configured such that each of the arms rotate away from the base 105 (in the direction of arrowed line G) when moving from the operational configuration to the storage configuration.

Referring back to FIG. 5, the apparatus further includes a first connector 145 connecting each of the legs near the bottom end of the legs, a second connector 146 connecting each of the arms near forward ends of the arms, a third connector connecting 147 each of the leas near the top end of the legs, and a fourth connector 148 connecting each of the arms near the rearward end of the arms.

The apparatus further includes a sheet of material 149. The sheet of material includes an outer surface 150 and an inner surface 151. The outer surface 150 of the sheet of material is comprised of a material that reflects the sun, and at least one of the outer and the inner surface of the sheet of material is comprised of a material that is water proof or water resistant. In one embodiment, the sheet of material may have dedicated areas for adding a message, logo, or other personalized item. The sheet of material can be made of any artificial or natural fabric or plastic materials that are sufficiently flexible to be rolled in the storage configuration and unrolled in the operational configuration.

In the operational configuration, a bottom end 152 of the sheet of material 149 is mounted on the first connecter, and a top end 153 of the sheet of material is mounted on the second connector such that a first surface 154 of the sheet of material faces towards the base and a second surface 155 faces away from the base. The bottom end 152 of the sheet of material 149 is turned back on itself to form an elongated bottom sleeve, and the first connector is inserted through the bottom elongated sleeve. Similarly, the top end 153 of the sheet of material 149 is turned back on itself to form a top elongated sleeve and the second connector is inserted through the top elongated sleeve. In the operating configuration, the sheet of material is positioned outward relative to the third connector and fourth connector.

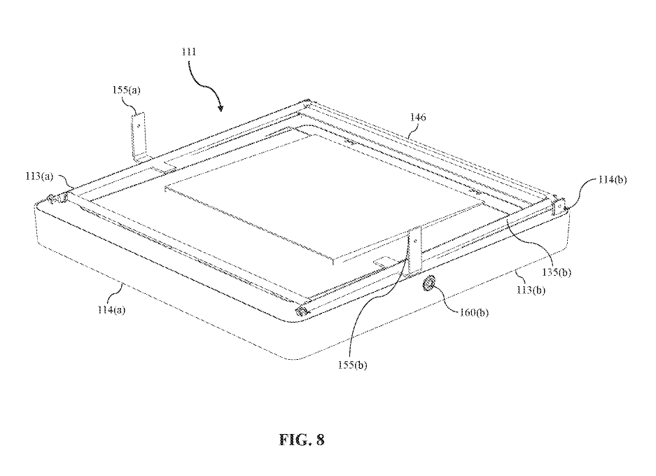

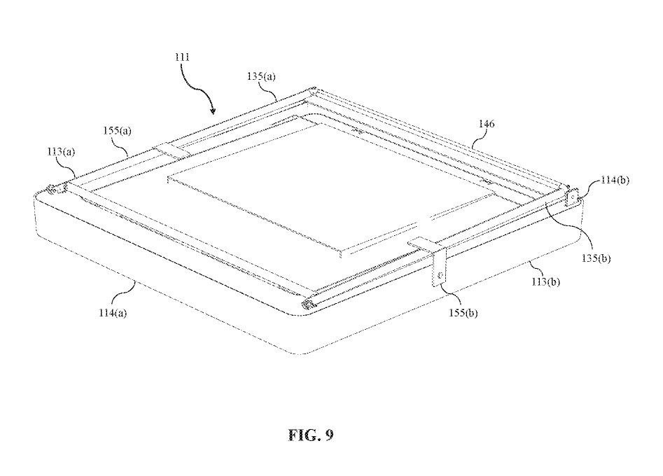

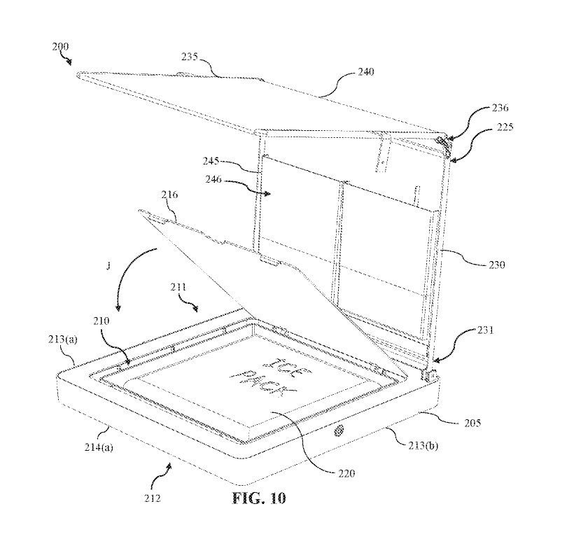

FIGS. 8 and 9 are top perspective views of illustrating a first part of a fastener 155(a), 155(b) on each of the arms, and a second part of a fastener 160(a), 160(b) on a first side and second side of the base. The first part of each fastener is configured to mate with the second part of each fastener to secure the apparatus in the storage configuration. It should also be appreciated that other attachment devices can be used to secure the apparatus in the storage configuration including screws, bolts, welds, pins, clamps, brackets, magnets, male-female interference-type connections, cable ties, waterproof adhesives, or any other suitable method known in the art.

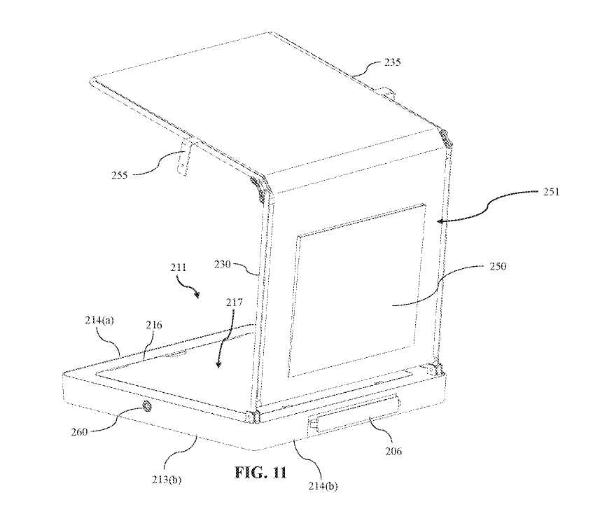

FIGS. 10 and 11 are front and rear perspective views, respectively, of a system for shading and cooling an article container, according to an example embodiment of the present invention. The system 200 includes a base 205 having a compartment 210 formed therein. In the present embodiment, the base 205 has a substantially planar square shaped body with rounded corners comprising an upward facing side 211, a downward facing side 212, two opposing sidewalls 213(a), 213(b) and two opposing end walls 214(a), 214(b). In another embodiment, the base includes a carrying handle 206 for conveniently carrying the apparatus. It should be appreciated that the base can have other shapes and dimensions, and such variations are within the spirit and scope of the claimed invention. In another embodiment, the base may have a dedicated area for adding a message, logo, or other personalized item. The base may be comprised of materials such as galvanized steel or iron, copper, polybutylene, unplasticized polyvinylchloride (PVC), chlorinated polyvinylchloride (CPVC) and polyethylene (PE) to increase corrosion resistance to specific environments, enhance oxidation resistance, and impart special characteristics.

A panel 215 enclosing the compartment is located on the upward facing side of the base. The panel may be connected to the base using a hinged connection or any other connection that allows the panel to be lifted upwards so that items may be placed in the compartment created therein. The panel may be formed from the same material as the base or may be formed from another suitable material. The system further includes a cooling element 220 inserted into the compartment. The cooling element is configured to cool articles resting on top of the panel via conduction. The cooling element may include ice, cold packs, freeze packs, or phase change material packs.

The system further includes a collapsible canopy structure 225 extending upwards from the planar base. The collapsible canopy structure comprises a vertical supporting element 230 hingedly attached at its bottom end 231 with the base, and a cantilevered element 235 hingedly attached with a top end 236 of the vertical supporting element. In the present embodiment, the vertical supporting element and the cantilevered element have a substantially planar rectangular shaped body, however, it should be appreciated that other shapes and dimensions can be used, and such variations are within the spirit and scope of the claimed invention.

A planar sheet 240 is mounted on the vertical supporting structure and the cantilevered element. The planar sheet includes an inward facing surface 246 and outward facing surface 251. A plurality of storage pockets 245 are attached to the inward facing surface 246 of the planar sheet. The storage pockets are configured to store items having various shapes and sizes. In one embodiment, the storage pockets include a closure mechanism to form a barrier between the storage pockets and the adjacent outside surface. The closure mechanism can be a zipper, a flap with a Velcro® strip, one or more snaps, a button, and hole, or any other generally accepted means in the art. A solar panel 250 for collecting solar energy is attached to the outward facing surface of the planar sheet. The solar panel is configured to charge electronic devices while keeping them cool and free from damage due to overheating. In one embodiment, the planar sheet may have dedicated areas for adding a message, logo, or other personalized item. The planar sheet can be made of any artificial or natural fabric or plastic materials that are sufficiently flexible to be rolled in a storage configuration and unrolled in an operational configuration.

The system is configured to move between a storage configuration and an operational configuration. In the storage configuration, the top end of the vertical supporting element is proximate to the base, and a frontward end of the cantilevered element is proximate to the bottom end of the vertical supporting element. In the operational configuration, the vertical supporting element is vertically arranged such that the vertical supporting element provides vertical structure support, and each cantilevered element is positioned above the base. Additionally, at least one of the vertical supporting element and cantilevered element provides shading for the article container.

The system further includes a first part of a fastener 255 on the cantilevered element, and a second part of a fastener 260 on a side of the base. The first part of the fastener is configured to mate with the second part of the fastener to secure the system in the storage configuration. It should also be appreciated that other attachment devices can be used to secure the apparatus in the storage configuration including screws, bolts, ⁻welds, pins, clamps, brackets, magnets, male-female interference-type connections, cable ties, waterproof adhesives, or any other suitable method known in the art.

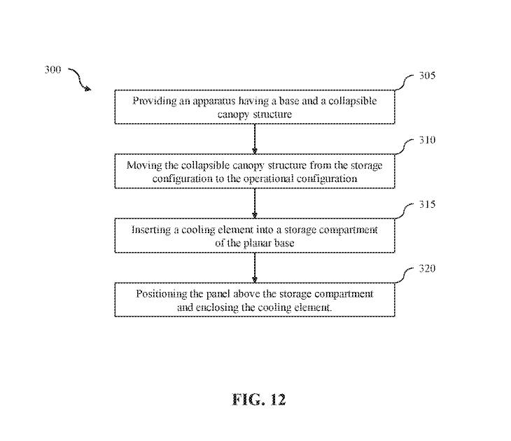

FIG. 12 is a flowchart describing the steps of the process for shading and cooling an article container, according to an example embodiment of the present invention. The sequence of steps depicted is for illustrative purposes only and is not meant to limit the method in any way as it is understood that the steps may proceed in a different logical order, additional or intervening steps may be included, or described steps may be divided into multiple steps, without detracting from the invention.

The process 300 begins with step 305, providing an apparatus having a base and a collapsible canopy structure extending upwards from the planar base. As described above with respect to FIGS. 10 and 11, the base 205 includes a compartment 210 formed therein. In the present embodiment, the base 205 has a substantially planar square shaped body with rounded corners comprising an upward facing side 211, a downward facing side 212, two opposing sidewalls 213(a), 213(b) and two opposing end walls 214(a), 214(b). It should be appreciated that the base can have other shapes and dimensions, and such variations are within the spirit and scope of the claimed invention. In another embodiment, the base may have a dedicated area for adding a message, logo, or other personalized items, and may also include a carrying handle 206 for conveniently carrying the apparatus. A panel 216 enclosing the compartment is located on the upward facing side 211 of the base. The panel may be connected to the base using a hinged connection or any other connection that allows the panel to be lifted upwards so that items may be placed in the compartment created therein.

The collapsible canopy structure comprises a vertical supporting element 230 hingedly attached at its bottom end 231 with the base, and a cantilevered element 235 hingedly attached with a top end 236 of the vertical supporting element. In the present embodiment, the vertical supporting element and the cantilevered element have a substantially planar rectangular shaped body, however, it should be appreciated that other shapes and dimensions can be used, and such variations are within the spirit and scope of the claimed invention.

In step 310, the process requires moving the collapsible canopy structure from the storage configuration to the operational configuration. In the storage configuration, shown in FIGS. 8 and 9, the top end 236 of the vertical supporting element 230 is proximate to the base, and a frontward end of the cantilevered element is proximate to the bottom end of the vertical supporting element. As shown in FIG. 6, to move the collapsible canopy structure from the storage configuration to the operational configuration, a first force is applied (in the direction of arrowed line K) to the vertical supporting element 230. The first force rotates the vertical supporting element 230 of the collapsible canopy structure to a substantially vertically aligned position. Additionally, a second force is applied (in the direction of arrowed line L) to the cantilevered element 235. As best shown in FIG. 3B, the second force rotates the cantilevered element of the collapsible canopy structure to a substantially horizontally aligned position such that a first abutting part 142 of a support element 141 abuts the cantilevered element and a second abutting part 143 of the support element 141 abuts the vertical supporting element such that the vertical supporting element is maintained in the substantially horizontally aligned position. In the operational configuration, shown in FIGS. 10 and 11, the vertical supporting element is vertically arranged such that the vertical supporting element provides vertical structure support, and each cantilevered element is positioned above the base.

In step 315, the process requires inserting a cooling element 320 into the compartment 210 of the base 205. The cooling element is configured to cool articles resting on top of the panel via conduction. The cooling element may include ice, cold packs, freeze packs, or phase change material packs.

In step 320, the process requires positioning the panel 216 above the compartment 210 of the base and enclosing the cooling element 220. As shown in FIG. 10, the panel may be connected to the base using a hinged connection or any other connection that allows the panel to be lifted upward in the opposite direction of line J so that items may placed inside the compartment 210 of the base 205. Upon completion of step 320, the apparatus is configured to provide shade and cooling to an article container (not shown) positioned on an upward facing surface 217 of the panel and below the collapsible canopy structure 225. Some of the forces applied to the apparatus may be applied using human muscle power.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. An apparatus for shading an article, the apparatus comprising:
a base;
at least two legs, each leg having a top end and a bottom end;
a first hinging element hingedly connecting the bottom end of each leg with the base such that each leg moves between a storage configuration and an operational configuration, wherein in the storage configuration the top end of each leg is proximate to the base, wherein in the operational configuration each leg is vertically arranged such that each leg provides vertical structure support;
at least two arms, each arm having a frontward end and a rearward end;
a second hinging element hingedly connecting the rearward end of each arm with the top end of one of the legs such that each arm moves between the storage configuration and the operational configuration, wherein in the storage configuration the frontward end of each arm is proximate to the bottom end of one of the legs, and wherein in the operational configuration each arm is horizontally arranged such that each arm provides horizontal structure support;
a first connector connecting each of the legs near the bottom end of the legs;
a second connector connecting each of the arms near forward ends of the arms;
a third connector connecting each of the legs near the top end of the legs;
a fourth connector connecting each of the arms near the rearward end of the arms;
a sheet of material; and,
wherein in the operational configuration a bottom end of the sheet of material is mounted on the first connecter and top end of the sheet of material is mounted on the second connector such that a first surface of the sheet of material faces towards the base and a second surface faces away from the base.

2. The apparatus of claim 1, wherein the base has a storage compartment formed within.

3. The apparatus of claim 1, where the second hinging element is configured such that each of the arms rotate away from the base when moving from the operational configuration to the storage configuration.

4. The apparatus of claim 1, wherein the bottom end of the sheet of material is turned back on itself to form an elongated bottom sleeve and wherein the top end of said sheet of material is turned back on itself to form a top elongated sleeve and wherein the first connector is inserted through the bottom elongated sleeve and wherein the second connector is inserted through the top elongated sleeve.

5. The apparatus of claim 1, wherein the operating configuration the sheet of material is positioned outward relative to the third connector and fourth connector.

6. The apparatus of claim 1, wherein the apparatus further comprises:
a first part of a fastener is on each of the arms;
a second part of a fastener is on a first side and second side of the base, wherein the first part of each fastener is configured to mate with the second part of each fastener; and
wherein in the collapsed configuration, the first part of the fastener attaches to the second part of the fastener.

7. The apparatus of claim 1 wherein the outer surface of the sheet of material is comprised of a material that reflects the sun.

8. The apparatus of claim 1, wherein at least one of the outer and the inner surface of the sheet of material are comprised of a material that is water resistant.

9. The apparatus of claim 1, wherein the second hinging element further comprises:
a support element having a first abutting part, a second abutting part, and a connecting part;
wherein the connecting part pivotally connects one of the arms to one of the legs;
wherein the first abutting part abuts the downward facing side of the arm and the second abutting part abuts the forward-facing side of the leg when in the operational configuration thereby providing an upward force maintaining the apparatus in the operational configuration; and,
wherein the first abutting part and second abutting part do not abut the leg and the arm when in the storage configuration.

10. The apparatus of claim 1, wherein the first hinging element further comprises:
a first wall facing a second wall, wherein the first and second wall protrude upward from the base;
a rearward support bar spanning from the first wall to the second wall;
a pin pivotally coupling the leg relative to the first wall and second wall;
a resilient element positioned between the first and second wall;
a ball positioned on top the upper end of the resilient element; and, wherein in the operating configuration a groove on the bottom end of the leg engages the ball and the rearward facing side of the leg is supported by the rearward support bar.

11. A system for shading and cooling an article container, the system comprising:
a base;
a cooling element inserted into a compartment; and
a collapsible canopy structure extending upwards from the planar base.

12. The system of claim 11, wherein the collapsible canopy structure comprises:
a vertical supporting element hingedly attached at its bottom end with the base;
a cantilevered element hingedly attached with a top end of the vertical supporting element;
a storage configuration, wherein in the storage configuration the top end of the vertical supporting element is proximate to the base and a frontward end of the cantilevered element is proximate to the bottom end of the vertical supporting element;
an operational configuration, wherein in open a configuration, the vertical supporting element is vertically arranged such that the vertical supporting element provides vertical structure support and each cantilevered element is positioned above the base;
wherein the system is configured to move between the storage configuration and the operational configuration; and,
wherein when in the operational configuration at least one of the vertical supporting element and cantilevered element provides shading for the article container.

13. The system of claim 11, wherein the base includes with a compartment formed therein and a panel enclosing the compartment.

14. The system of claim 12, wherein the vertical supporting structure and the cantilevered element having a planar sheet mounted thereon.

15. The system of claim 12, wherein the apparatus further comprises:
a first part of a fastener on the cantilevered element;
a second part of a fastener is on a side a of the base, wherein the first part of the fastener is configured to mate with the second part of each fastener; and
wherein in the collapsed configuration the first part of the fastener attaches to the second part of the fastener.

16. The system of claim 14, wherein the system further comprises a plurality of storage pockets attached to an inward facing surface of the planar sheet mounted on the vertical supporting element.

17. The apparatus of claim 14 further comprising a solar panel for collecting solar energy attached to an outward facing surface of the planar sheet.

18. A method for shading and cooling an article container, the method comprising:
providing an apparatus having a base and a collapsible canopy structure extending upwards from the planar base, wherein the planar base includes a compartment formed therein and a panel enclosing the compartment, and wherein the collapsible canopy structure has a storage configuration and an operational configuration;
moving the collapsible canopy structure from the storage configuration to the operational configuration;
inserting a cooling element into a storage compartment of the planar base; and,
positioning the panel above the storage compartment and enclosing the cooling element.

19. The method of claim 18, wherein the method further includes positioning the article container on an upward facing surface of the panel and below the collapsible canopy structure.

20. The method of claim 18, wherein moving the collapsible canopy structure from the storage configuration to the operational configuration further includes:
applying a first force to rotate a leg of the collapsible canopy structure to substantially vertically aligned position;
applying a second force to rotate an arm of the collapsible canopy structure to a substantially horizontally aligned position such that a first abutting part of a support element abuts the arm and a second abutting part of the support element abuts the leg such that the leg is maintained in the substantially horizontally aligned position.
